(19) United States
(12) Patent Application Publication
(10) Pub. No.: US 2025/0193310 A1
(43) Pub. Date: Jun. 12, 2025

(54) COMMUNICATION SYSTEM NODE HAVING MULTIPLE MODULES AND A SHARED MEMORY

(71) Applicant: Afiniti AI Limited, Dublin 2 (IE)

(72) Inventors: Qiaobing XIE, Chesterfield, MO (US); Ain CHISHTY, Rockville, MD (US)

(73) Assignee: Afiniti AI Limited, Dublin 2 (IE)

(21) Appl. No.: 18/982,749

(22) Filed: Dec. 16, 2024

Related U.S. Application Data
(63) Continuation of application No. PCT/US2023/025871, filed on Jun. 21, 2023.
(60) Provisional application No. 63/354,571, filed on Jun. 22, 2022.

(51) Int. Cl. H04M 3/51; H04M 3/523

(52) U.S. Cl. CPC H04M 3/5141; H04M 3/5175; H04M 3/523; H04M 2201/36

(57) ABSTRACT

A contact center system. The contact center system comprises a node comprising a plurality of modules (e.g., microservices), each module comprising a shared memory module (e.g., shared memory library), wherein the shared memory module is configured to: obtain a shared memory key; obtain a shared memory segment identifier (smhid) using the shared memory key, the shared memory segment identifier identifying a shared memory segment; use the shared memory segment identifier to attach to the shared memory segment, wherein, for each of a plurality of memory block sizes, the shared memory segment stores information pertaining to a recycle list, and the plurality of memory block sizes comprises a first memory block size and a second memory block size that is greater than the first memory block size.

### CROSS-REFERENCE TO RELATED APPLICATIONS

This application is a continuation of International Patent Application No. PCT/US2023/025871, filed on 2023 Jun. 21, which claims priority to U.S. Provisional Patent Application No. 63/354,571, filed on 2022 Jun. 22. The above identified applications are incorporated by this reference.

### TECHNICAL FIELD

Disclosed are embodiments related to a node of a communication system.

### BACKGROUND

An example of a communication system is a contact center system (a.k.a., call center system). A contact center system may employ a pairing node that functions to assign contacts (a.k.a., calls or callers) to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment.

### SUMMARY

Certain challenges presently exist. For instance, conventional contact center systems do not have enough capacity to handle many concurrent agents, nor do they have enough throughput to handle a high rate of incoming contacts. Consequently, conventional contact center systems typically require additional infrastructure such as load balancers to manage load across multiple systems (e.g., multiple automated call distributors or ACDs having groups of agents divided among them). Therefore, it is advantageous for a communication system, such as, for example, a contact center system, to manage computational resources including CPU, network bandwidth, and memory efficiently perform necessary operations as quickly as possible and reduce or eliminate the need for load balancers or other additional computational resources and infrastructure.

Accordingly, in one aspect there is provided a contact center system, comprising a node comprising a plurality of modules (e.g., microservices), each module comprising a shared memory module (e.g., shared memory library), wherein the shared memory module is configured to: obtain a shared memory key; obtain a shared memory segment identifier (smhid) using the shared memory key, the shared memory segment identifier identifying a shared memory segment; use the shared memory segment identifier to attach to the shared memory segment, wherein, for each of a plurality of memory block sizes, the shared memory segment stores information pertaining to a recycle list, and the plurality of memory block sizes comprises a first memory block size and a second memory block size that is greater than the first memory block size.

In another aspect there is provided a method in a contact center system comprising a plurality of services (containers, virtual machines) configured to operate using a shared memory, the method comprising: upon arrival of a caller, storing a caller state object in an allocated portion of the shared memory (i.e., a free memory block within the shared memory) by a first service in a first container; after the caller is placed on hold, managing the caller by a second service in a second container by reading and updating the caller state object in the allocated portion of the shared memory; and connecting the caller to an agent by reading and updating the caller state object.

In another aspect there is provided a method comprising: storing in a shared memory segment first recycle list information pertaining to a first recycle list associated with a first memory block size; storing in the shared memory segment second recycle list information pertaining to a second recycle list associated with a second memory block size that is larger than the first memory block size; and using the first and second recycle lists to manage the allocation of memory within the shared memory segment.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

### BRIEF DESCRIPTION OF THE DRAWINGS

The accompanying drawings, which are incorporated herein and form part of the specification, illustrate various embodiments.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2 illustrates a paring node of a contact center according to an embodiment.

FIG. 3 illustrates a generic node of a communication system according to an

embodiment.

FIG. 4 is a flowchart illustrating a process according to an embodiment.

FIG. 5 is a flowchart illustrating a process according to an embodiment.

FIG. 6 is a flowchart illustrating a process according to an embodiment.

FIG. 7 is a flowchart illustrating a process according to an embodiment.

FIG. 8 is a flowchart illustrating a process according to an embodiment.

FIG. 9 is a flowchart illustrating a process according to an embodiment.

FIG. 10 is a block diagram of a node according to an embodiment.

### DETAILED DESCRIPTION

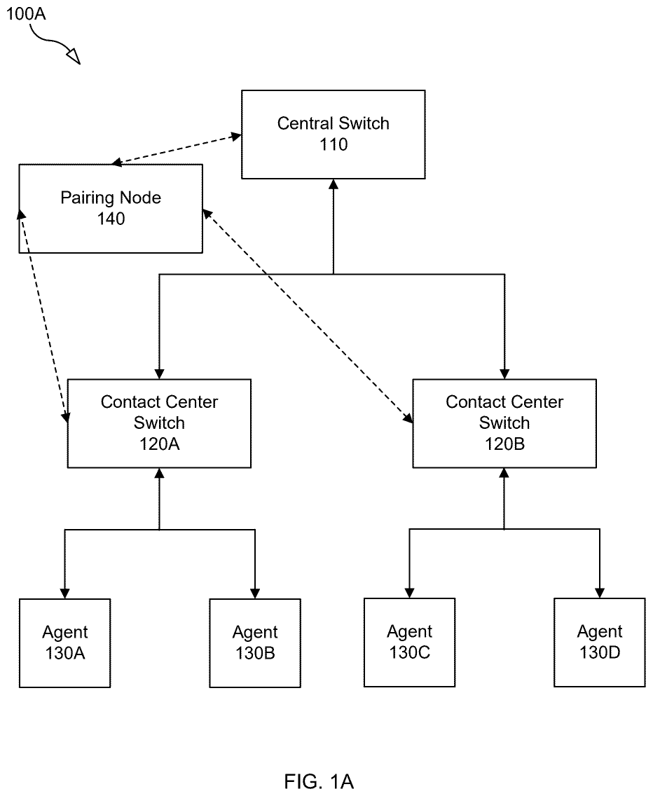

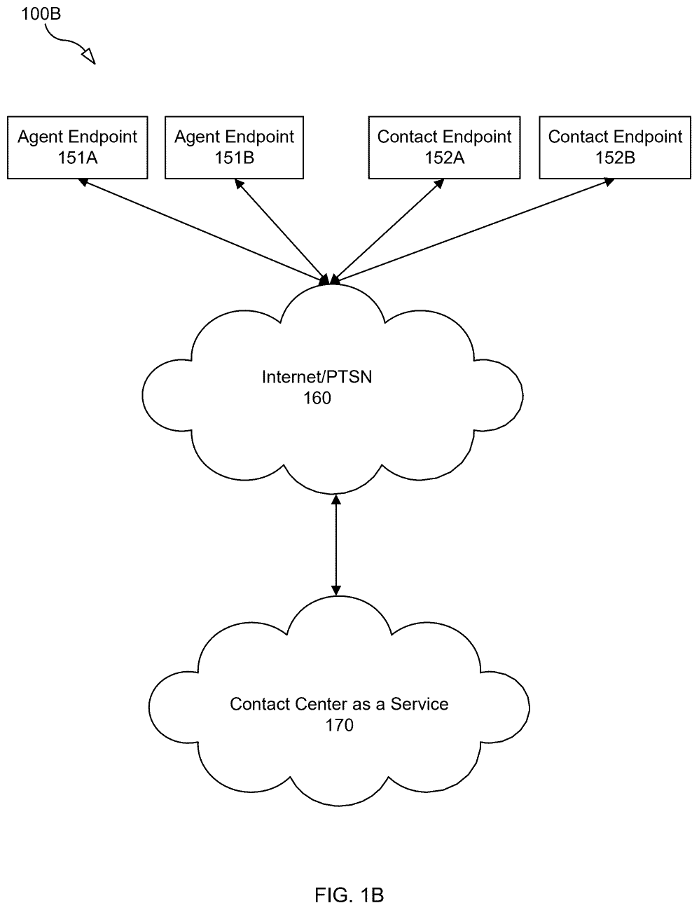

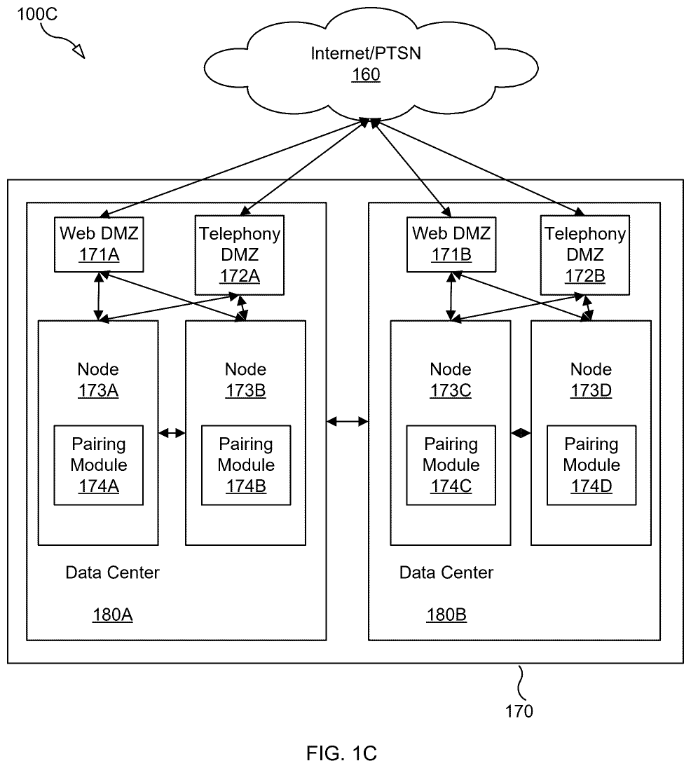

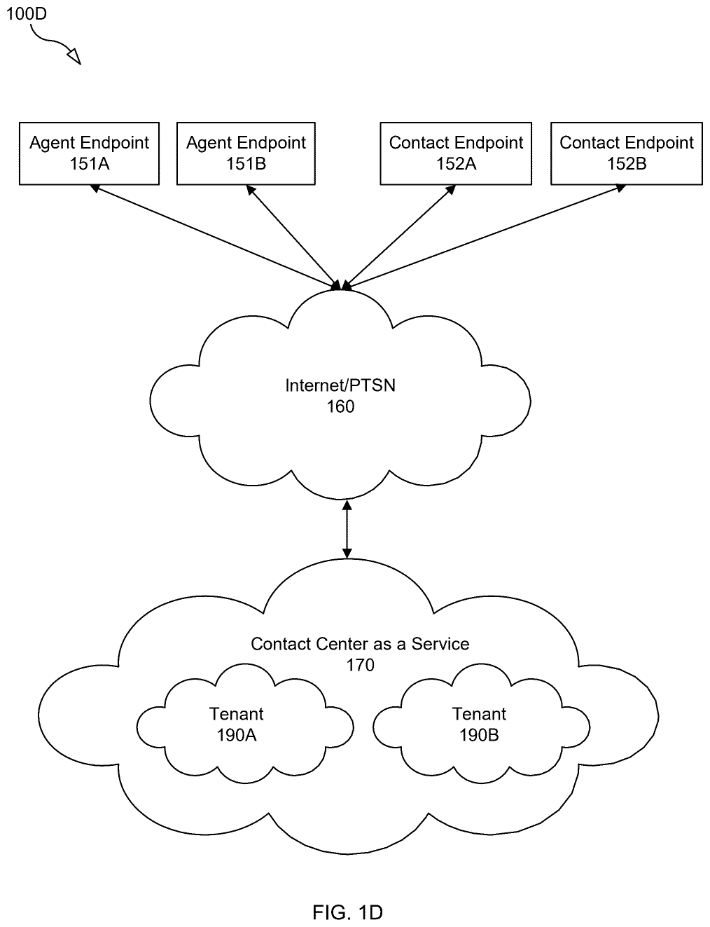

FIG. 1A illustrates an example communication system 100A. In this example, communication system 100A is a contact center system. As shown in FIG. 1A, the communication system 100A may include a central switch 110. The central switch 110 may receive incoming contacts (e.g., telephone callers or other callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing node 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone (DMZ) equipment 171A and 171B, respectively, which is configured to receive the agent endpoints 151A, 151B and contact endpoints 152A, 152B, which are communicatively connecting to CCaaS via the Internet. DMZ equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in, First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine. In other embodiments, the system may be configured for multiple tenants on the premises of a business process outsourcer (BPO) or other service provider.

Contact centers often have several services operating within a computer node at any time, competing for processing power and bandwidth. Each service may have a private section of memory allocated to it, and these services conventionally pass objects, or information blocks, from service to service, through the kernel of a conventional operating system. This is a slow process due to the time constraints of (1) copying objects or other data through conventional data replication techniques, and (2) requiring additional processing power for kernel-based operations, such as running additional checks to protect each service's individual memory allocation and multitasking overhead. The kernel becomes more and more overburdened for larger contact center systems, quickly reaching capacity and/or throughput limits and creating other bottlenecks within the system. Accordingly, conventional communication systems are low fault tolerance systems. For example, a microservice may not receive an object by the time the microservice needs to perform an action on said object (e.g., update state, append additional details, link to another object, establish a connection, etc.). This failure to receive an object leads to stalling, and may even force the microservice restart if the time waited is long enough. Therefore, a conventional microservice is reliant on the speed of other microservices; or otherwise required to use locking techniques and subject to race conditions with other microservices, further limiting the capacity and/or throughput of the system to manage these types of overhead.

Further, the competition between microservices and the time efficiency constraints of conventional contact center node architecture limits the capacity of conventional contact centers.

The present disclosure newly provides systems and methods for applying a shared memory node architecture for use in a contact center system, as discussed herein. The systems and methods discussed herein provide for a contact center with greatly increased speed, efficiency, processing power, and bandwidth. For example, where conventional contact centers typically handle less than a 12 calls per second, and less than 1,000 caller or agent total capacity at the contact center system, the systems and methods of the present disclosure newly provide a contact center with a capacity for 100 or more calls per second, and over 100,000 caller or agent total capacity.

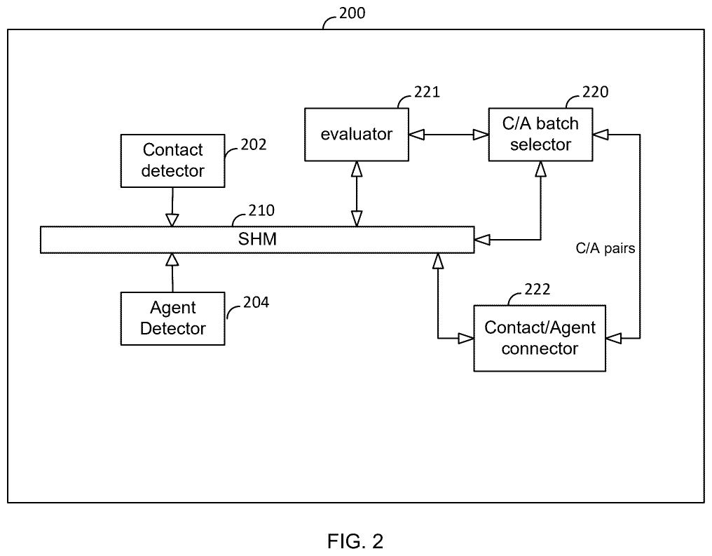

FIG. 2 illustrates an example pairing node 200 according to one embodiment (that is, for example, L3 pairing node 140 of FIG. 1A, or nodes 173A, 173B, 173C, 173D of FIG. 1B may be implemented using pairing node 200). In the embodiment shown, pairing node 200 includes physical memory 210 (e.g., random access memory RAM) such as dynamic RAM (DRAM) or static RAM (SRAM)) for storing contact center information that identifies: (i) a set of contact identifiers (IDs) associated with contacts available for pairing (i.e., contacts waiting to be connected to an agent) and (ii) a set of agent IDs associated with agents available for pairing. In some embodiments, the contact center information includes: i) for each contact ID, metadata for the contact associated with the contact ID (this metadata may include state information indicating whether the contact is available (i.e., waiting to be paired), a score assigned to the contact and/or information about the contact) and ii) for each agent ID, metadata for the agent associated with the agent ID (this metadata may include state information indicating whether the agent is available, a score assigned to the agent and/or information about the agent).

Exemplary information about the contacts and/or agents that may be stored in memory 210 and is associated with the contact ID or agent ID includes: attributes, arrival time, hold time or other duration data, estimated wait time, historical contact-agent interaction data, agent percentiles, contact percentiles, a state (e.g., ‘available’ when a contact or agent is waiting for a pairing, ‘abandoned’ when a contact disconnects from the contact center, ‘connected’ when a contact is connected to an agent or an agent is connected to a contact, ‘completed’ when a contact has completed an interaction with an agent, ‘unavailable’ when an agent disconnects from the contact center) and patterns associated with the agents and/or contacts.

Pairing node 200 also includes several modules (software and/or hardware components) (e.g., microservices) including a contact detector 202 and an agent detector 204. Contact detector 202 is operable to detect an available contact (e.g., contact detector 202 may be in communication with a switch that signals contact detector 202 whenever a new contact calls the contact center) and, in immediate response to detecting the available contact, store in memory 210 at least a contact ID associated with the detected contact (the metadata described above may also be stored in association with the contact ID). Similarly, agent detector 204 is operable to detect when an agent becomes available and, in immediate response to detecting the agent becoming available, store in memory 210 at least an agent identifier uniquely associated with the detected agent (metadata pertaining to the identified agent may also be stored in association with the agent ID). In this way, as soon as a contact/agent becomes available, memory 210 will be updated to include the corresponding contact/agent identifier and state information indicating that the contact/agent is available. Hence, at any given point in time, memory 210 will contain a set of zero or more contact identifiers where each is associated with a different contact waiting to be connected to an agent, and a set of zero or more agent identifiers where each is associated with a different available agent.

Pairing node 200 further includes other modules (e.g., microservices) including: (i) a contact/agent (C/A) batch selector 220 that functions to identify (e.g., based on the state information) sets of available contacts and agents for pairing, and provide state updates (i.e., modify the state information) for contacts and agents once the contacts and agents are selected for pairing and (ii) a C/A pairing evaluator 221 that functions to evaluate information associated with available contacts and information associated with available agents in order to propose contact-agent pairings. As shown in FIG. 2, C/A batch selector 220 is in communication with memory 210, and, thereby, can read from memory 210 the contact center information stored therein (e.g., a set of contact IDs where each contact ID identifies an available contact and a set of agent IDs where each agent ID identifies an available agent). In one embodiment, C/A batch selector 220 is configured to occasionally (e.g., periodically) read memory 210 to obtain a list of available contacts and available agents based on a state associated with the agents and contacts listed in the memory 210. Further, the C/A batch selector 220 is in contact with a C/A pairing evaluator 221, and, after obtaining a list of available contacts and available agents, the C/A batch selector 220 may send the list to the C/A pairing evaluator 221 (e.g., sending contact IDs and agent IDs to the C/A pairing evaluator 221).

After the C/A pairing evaluator 221 receives a set of contact IDs and agent IDs from the C/A batch selector 220, the C/A pairing evaluator 221 may read from memory 210 further information about the received contact IDs and agent IDs. The C/A pairing evaluator 221 uses the read information in order to identify and propose agent-contact pairings for the received contact IDs and agent IDs based on a pairing strategy, which, depending on the pairing strategy used and the available contacts and agents, may result in no contact/agent pairings, a single contact/agent pairing, or a plurality of contact agent pairings.

Upon identifying contact/agent pairing(s), the C/A pairing evaluator 221 sends the set of contact/agent pairing(s) to the batch selector 220. The C/A batch selector 220 provides the set of contact/agent pairing(s) to a contact/agent connector 222 (e.g., if the contact associated with contact ID C12 is paired with the agent associated with the agent ID A7, then C/A batch selector 220 provides these contact/agent IDs to contact/agent connector 222). If the pairing process results in one or more contact/agent pairings, then, for each contact/agent pairing, C/A batch selector 220 will transmits an updated state associated with each contact ID and each agent ID in the one or more contact/agent pairings to memory 210, which is then associated with each contact ID and agent ID. Thereby, memory 210 retains the contact IDs and agent IDs for future analysis.

Contact/agent connector 222 functions to connect the identified agent with the paired identified contact. Further, C/A connector 222 transmits an updated state associated with each contact ID and each agent ID in the one or more contact/agent pairings to memory 210, which is then associated with each contact ID and agent ID.

Therefore, in one embodiment, pairing node 200 provides an asynchronous polling process where memory 210 provides a central repository that is read and updated by the contact detector 202, agent detector 204, C/A batch selector 220, C/A pairing evaluator 221, and C/A connector 222. Accordingly, the objects of each agent and contact do not need to be moved or copied among the microservices of pairing node 200; instead, identifiers associated with the objects are transmitted or shared among the contact detector 202, agent detector 204, memory 210, C/A batch selector 220, C/A pairing evaluator 221, and C/A connector 222, and the objects stay in place within memory 210, which is shared and accessible to each microservice without the need to rely on an operating system kernel to facilitate data copying among the microservices. This process conserves bandwidth, processing power, memory associated with each microservice, and is more expedient than conventional event-based pairing nodes.

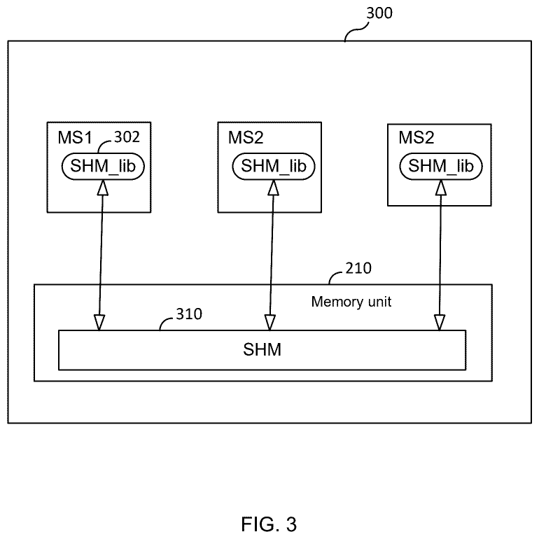

FIG. 3 illustrates a generic node 300 of a communication system according to an embodiment. In the embodiment shown, node 300 includes modules (e.g., microservices) and a shared memory segment (SHM) 310 within memory 210. Specifically, in the example shown, node 300 includes three microservices: MS1, MS2, and MS3. Each microservice includes a shared memory submodule 302 (a.k.a., shared memory library (SHM_lib)) that enables the microservice in which it is contained to read from and write to SHM 310. In one embodiment, each microservice is contained within its own container (e.g., a Docker® container). In one embodiment, one or more of the modules of node 200 (e.g., evaluator 221, batch selector 220, etc.) includes an instance of SHM_lib 302. In some embodiments, each microservice is trusted to operate on shared memory segment 310 through functions of SHM_lib 302, eliminating the need for an operating system kernel to manage memory protection among different microservices. Moreover, each microservice may be developed and maintained more efficiently because any complexity of operating on shared memory segment 310 is implemented and managed by the SHM_lib 302 of each microservice.

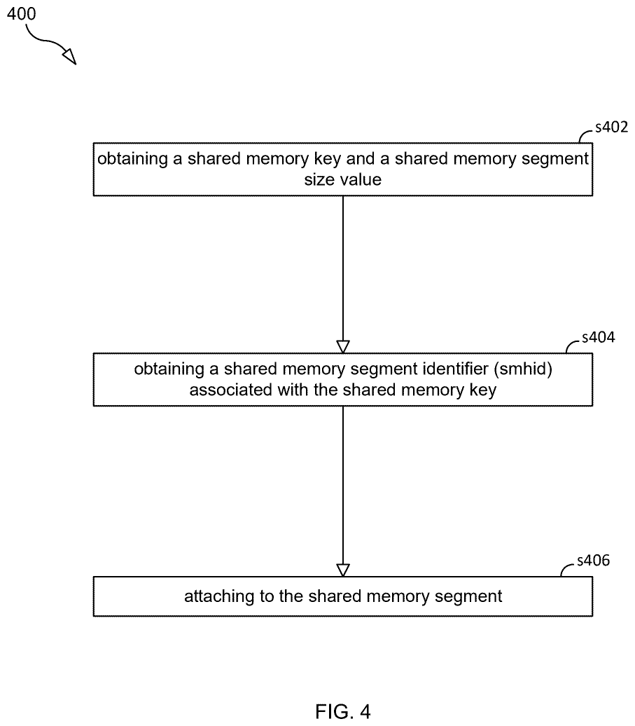

FIG. 4 is a flow chart illustrating a process 400, according to an embodiment, performed by one or more modules of node 200 or 300. Process 400 may begin in step s402.

Step s402 comprises the module obtaining a shared memory key and a shared memory segment size value. For example, in one embodiment the module obtains the key by reading a predefined configuration file that contains the key and the size value. The key may be any arbitrary integer value. Each module of node 200/300 may have the same configuration information so that each module will obtain the same key.

Step s404 comprises the module obtaining a shared memory segment identifier (smhid) associated with the shared memory key. For example, in one embodiment the module invokes the shmget function with the key as the first argument of the function and the size value as the second argument of the function. Calling the shmget function will return the shmid and create the shared memory segment if it does not yet exist.

Steps s406 comprises the module attaching itself to the shared memory segment. For example, the module may call the shmat function with the shmid as an argument to the function. The shmat function attaches the shared memory segment associated with the shared memory identifier specified by shmid to the address space of the calling process (i.e., the module).

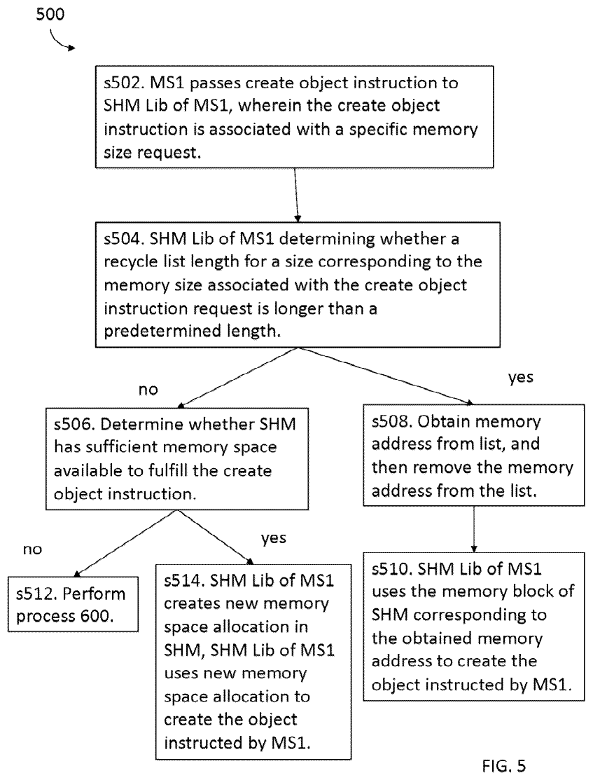

FIG. 5 is a flow chart illustrating a process 500, according to an embodiment, performed by a module of node 200 or 300 for creating an object in SHM 310. Process 500 may begin in step s502.

Step s502 comprises the module passing a create object instruction to lib 302, wherein the create object instruction is associated with a specific memory size. For example, step s502 may comprise the module invoking a create object function provided by lib 302, wherein one of the arguments to the function is a size value.

Step s504 comprises lib 302 determining whether a recycle list length for a size corresponding to the memory size associated with the create object instruction request is longer than a predetermined length. A recycle list is a data structure (e.g., an array or a linked list) for storing a set of memory addresses, wherein each memory address points to a block of memory that has been “recycled” (i.e., the block of memory is free to be written to). In some embodiments, the use of recycle lists reduces or eliminates the need to use the kernel for additional memory allocation, deallocation, garbage collection, defragmentation, and other memory management, and the use of recycle lists also reduces the need for lib 302 to delete, collect, or defragment reusable blocks of memory. The use of recycle lists also reduces memory thrashing, the need for locking or otherwise managing race conditions, and improves fault tolerance within the system by controlling how quickly individual blocks of memory become available for reuse for a new object or other data.

In one embodiment, a set of size values is defined (e.g., the set may contain the following values of 10, 15, 20, 30, 50, values of 16, 32, 64, 128, 256, etc.) and a recycle list may be created for each size value in the set. Hence, if the set of values consists of five values, then five recycles list may be created, one for each size value. Additionally, in some embodiments, each size value is associated with a different memory block within SHM 310, and, the memory block associated with the particular size value may contain a data structure comprising an IE storing value (i.e., pointer) that specifies a memory location in SHM 310 that stores at least a portion of the recycle list (e.g., the head or front of the recycle list); additionally, the data structure may comprise a second IE storing a second pointer that points to the tail or rear of the recycle list and a third IE storing a value specifying the number of items (i.e. length) of the recycle list.

For example, step s504 comprises lib 302 determining the length of the recycle list (e.g., the number of memory addresses stored in the list) and then compares the determined length to a predefined threshold value. If the determined length is greater than the threshold value, then the process proceeds to step s508, otherwise the process goes to step s506.

In some embodiments, each memory size included in the set of memory sizes is associated with a threshold value (e.g., the threshold values may be different for different memory sizes). Each such threshold value may be determined based on historical data regarding the size value with which the threshold value is associated. The historical data regarding a size value may include: average length of use for memory blocks of the size indicated by the size value, how static are such memory blocks, how many module access such memory blocks. Typically, it is expected that larger memory blocks are generally static and not used by many modules, whereas smaller objects are more dynamic, and usually shared. Thus, a small size value is expected to have a greater threshold value than a larger size value.

Step s508 comprises lib 302 obtaining a memory address stored in the recycle list and then removing the memory address from the list. For example, where the recycle list is implemented using a linked list, step s508 may comprises lib 302 obtaining the memory address from the current head of the linked list and “removing” the current head from the list such that the block immediately following the current head becomes the new head of the list. In one embodiment, lib 302 “removes” the current head by storing in the memory block associated with the size value the next block pointer contained in the current head of the list, which next block pointer is the memory address of the next block in the list.

Step s510 comprises lib 302 storing the object in the memory block of SHM 310 corresponding to the obtained memory address or reserving the memory block. For example, step s510 comprises lib 302 using the memory block of SHM 310 corresponding to the obtained memory address to create the object instructed by MS1.

Step s506 comprises lib 302 determining whether SHM 310 has sufficient memory space available to fulfill the create object instruction. If SHM 310 has sufficient memory space available to fulfill the create object instruction, then the process proceeds to step s514, otherwise the process goes to step s512.

Step s514 comprises lib 302 obtaining a free memory block within SHM 310 and storing the object in the obtained memory block or reserving a memory block. In either case, the memory block will no longer be a “free” memory block. For example, step s514 comprises lib 302 using the obtained or reserved memory block to create the object instructed by MS1.

Step s512 comprises the process performing process 600, as described further below.

Therefore, process 500 provides a resource efficient method for allocating memory blocks to microservices, and this efficiency provides particular advantages in a contact center system. As shown in node 200, many microservices may be operating on the same objects in memory simultaneously, or near simultaneously. Process 500 provides that a first microservice can delete an object (e.g., as discussed in process 700 below), even if a second microservice is still operating on the object, because the object would remain in shared memory (albeit at the end of a recycle list) for the second microservice to read, write, update state information, etc. The fact that no other microservice would use the changes made to shared memory by the second microservice does not matter, because each microservice can proceed with their tasks as intended, reducing overhead from locks or other race condition management, increasing speed, and improving fault tolerance.

By contrast, in a conventional contact center node, if an object were required for multiple microservice usage, and the object were deleted by a first microservice before being sent to a second microservice, the second microservice would experience data corruption, stalling as the second microservice waits for an object that will never be sent, and, in the worst case, experience a microservice module failure requiring the microservice to be restarted.

Accordingly, process 500 minimizes any microservice restarts and increases the speed of operation for a contact center node.

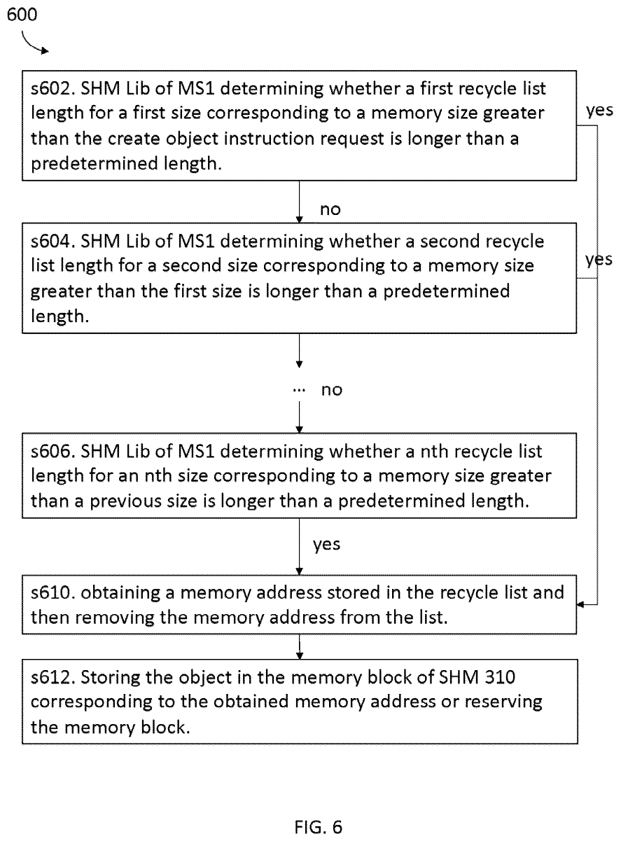

FIG. 6 is a flow chart illustrating process 600. Process 600 may begin in step s602.

Step s602 comprises lib 302 determining whether a first recycle list length for a first size corresponding to a memory size greater than the create object instruction request is longer than a first predetermined length. For example, step s602 comprises lib 302 determining the length of the recycle list (e.g., the number of memory addresses stored in the list) and then comparing the determined length to a predefined threshold value associated with the memory size of said recycle list. If the first recycle list length is longer than the first predetermined length, the process proceeds to step s610, otherwise the process goes to step s604.

Step s604 comprises lib 302 determining whether a second recycle list length for a second size corresponding to a memory size greater than the first size is longer than a second predetermined length. If the second recycle list length is longer than the second predetermined length, the process proceeds to step s610, otherwise the process goes to step s606.

For example, step s604 may repeat for progressively larger list sizes until the process reaches an “nth” list size. Step s606 comprises lib 302 determining whether an nth recycle list length for an nth size corresponding to a memory size greater than a previous size is longer than an nth predetermined length. When the nth recycle list length is longer than the nth predetermined length, the process proceeds to step s610.

Step s610 comprises lib 302 obtaining a memory address stored in the recycle list (e.g., the recycle list which is longer than its associated predetermined length according to any of steps s602, s604, and s606), and then removing the memory address from the list.

Step s612 comprises lib 302 storing the object in the memory block of SHM 310 corresponding to the obtained memory address or reserving the memory block. In either case, the memory block will no longer be a “free” memory block.

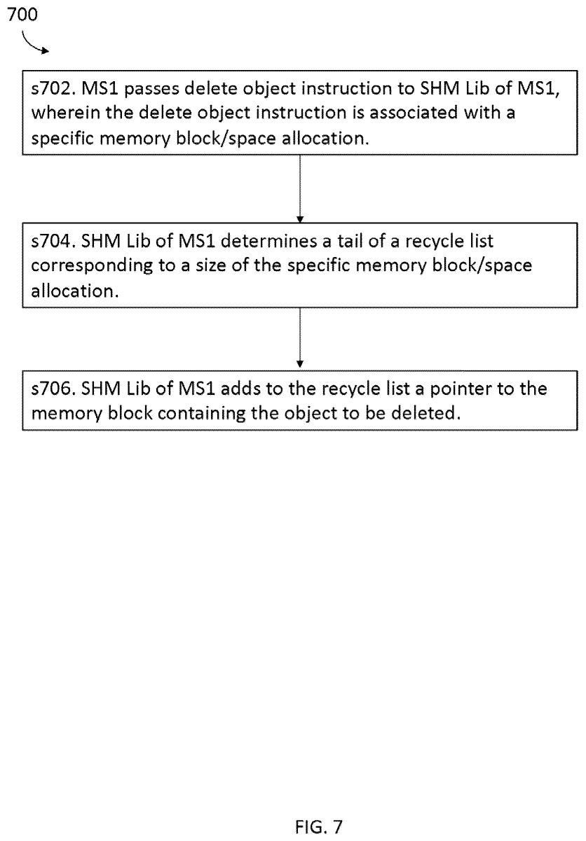

FIG. 7 is a flow chart illustrating a process 700, according to an embodiment, performed by a module of node 200 or 300 for deleting an object in SHM 310. Process 700 may begin in step s702.

Step s702 comprises the module passing a delete object instruction to lib 302, wherein the delete object instruction is associated with a specific memory block and a memory size. For example, step s702 may comprise the module invoking a delete object function provided by lib 302, wherein one of the arguments to the function is an object identifier (ID) identifying the object to be deleted and lib 302 maintains a mapping (e.g., a table) that maps the object ID to (i) a memory address (a.k.a., pointer) specifying the memory block where the object is stored and (ii) a memory size. For example, step s702 may comprise the module invoking a delete object function provided by lib 302, wherein one of the arguments to the function is the memory address associated with the object to be deleted.

Step s704 comprises lib 302 determining a “tail” of a recycle list corresponding to a size of the specific memory block/space allocation. For example, the “tail” may be the end of a linked list, the end of a data structure, etc.

Step s706 comprises lib 302 storing in the recycle list a pointer to the memory block that contains the object to be deleted. For example, in one embodiment in which the recycle list is implemented using a linked list, step s708 comprises: (i) obtaining pointer to a free memory block; (ii) storing in the free memory block a data structure comprising the pointer to the memory block that contains the object to be deleted; (iii) modifying the current tail of the recycle list by storing in the current tail the pointer to the free memory block, thereby making the free memory block the new tail of the linked list; and (iv) incrementing a length value that specifies the length of the recycle list (as noted above, this length value may be stored in the head of the recycle list). In some embodiments, a first module within a node (e.g.,. MS1) can communicate with a second module within the node (e.g., MS2) via their respective libs 302 and SHM 310.

That is, the object is not deleted, and other microservices may still operate on the object, while said object is associated with a recycle list. In one embodiment, storing the pointer in the recycle list comprises storing in the free memory block a data structure comprising the pointer to the memory block that contains the object to be deleted. The data structure may also contain a pointer to the next block, if any, in the recycle list.

For example, when MS1 has a message to send to MS2, MS1 can provide to its lib 302 a send message instructions that contains the message to be sent and a certain channel identifier (CID) associated with a particular message queue in shared memory (e.g., shared memory 310), which message queue is monitored by MS2. The CID can be any arbitrary value.

When the lib 302 receives the instruction, the lib 302 uses the CID to locate the rear (i.e., tail) of the message queue associated with the CID. For instance, in one embodiment, a predefined memory block in SHM 310 is allocated for the CID and this predefined memory block stores a tail pointer pointing to the tail of the message queue. The predefined memory block may also store a head pointer pointing to the head of the message queue.

After locating the rear of the message queue, lib 302 adds the message to a free memory block and updates the tail pointer so that the tail pointer points to the memory block in which the message was stored, thereby making the message the last message in the queue. Additionally, in an embodiment in which the message queue is implemented using a linked list, lib 302 may modify the memory block that was previously at the rear of the message queue so that this memory block comprises a next-block-pointer that points to the memory block in which the message was stored.

The lib 302 of MS2 can monitor the message queue allocated to the CID to determine when a message has been added. For instance, as noted above, a specific memory block in SHM 310 can be allocated to the CID and the lib 320 of MS2 can periodically read this memory block to see if the memory block has been updated. In one example, when the message queue goes from an empty state (no message in queue) to a non-empty state (one or more message in the queue) the memory block will go from a state in which the memory block indicates no messages are in the queue to a state in which the memory block indicates one or more message in the queue (e.g., the head pointer may go from a zero (0) value indicating empty queue to a positive value indicating at least one message in the queue). In another example, the lib 320 of MS2 may periodically read the first message at a head of the message queue.

In another example, the lib 320 of MS2 read the first message at a head of the message queue in response to a “read message at head of message queue” instruction from MS2, which is associated with the CID of the message queue. For example, MS2 may copy or replicate the message into a personal buffer or memory space associated with MS2, and then pass a “message reading complete” instruction to lib 320 of MS2. Receiving a “message reading complete” instruction causes MS2 to delete the message in accordance with process 700. In other examples, where the MS2 does not copy the message into a personal buffer or memory space, MS2 may still send a “message reading complete” instruction to lib 320 of MS2. In the same manner, MS2 can send message to MS1 using a CID that is associated with a particular message queue that is monitored by MS1.

In some embodiments, a module (MS1) can send a message to a group of modules. For example, in one embodiment, a particular CID is associated with a message queue that is monitored by each module in the group. Hence, to send a message to the group, MS1 need only provide to its lib 302 a send message instructions that contains the message to be sent and the particular CID because this will cause the lib to add the message to the message queue associated with the particular CID. When the lib 302 adds the message to the message queue the lib may initialize a counter to the value (e.g., zero). Each time another lib accesses the message for the first time, lib 302 increments the counter. When value of the counter reaches the number of modules in the group this means that all intended recipients have accessed the message and the message can be removed from the queue and the memory block containing the message can be added to a recycle list associated with a size of the memory block. In other examples, the counter is initialized to a number of modules in the group, and then reduce the counter each time a recipient accesses the message, until the value of the counter reaches zero; then the message can be removed from the queue and the memory block containing the message can be added to a recycle list associated with a size of the memory block.

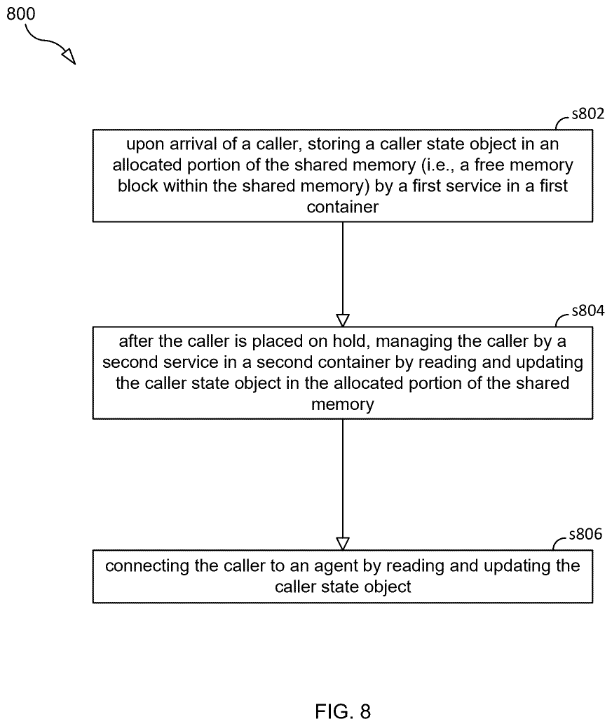

FIG. 8 is a flow chart illustrating a process 800, according to an embodiment, performed in a contact center system comprising a plurality of services (containers, virtual machines) configured to operate using a shared memory. Process 800 may begin in step s802. Step s802 comprises upon arrival of a caller, storing a caller state object in an allocated portion of the shared memory (i.e., a free memory block within the shared memory) by a first service in a first container. Step s804 comprises, after the caller is placed on hold, managing the caller by a second service in a second container by reading and updating the caller state object in the allocated portion of the shared memory. Step s806 comprises connecting the caller to an agent by reading and updating the caller state object.

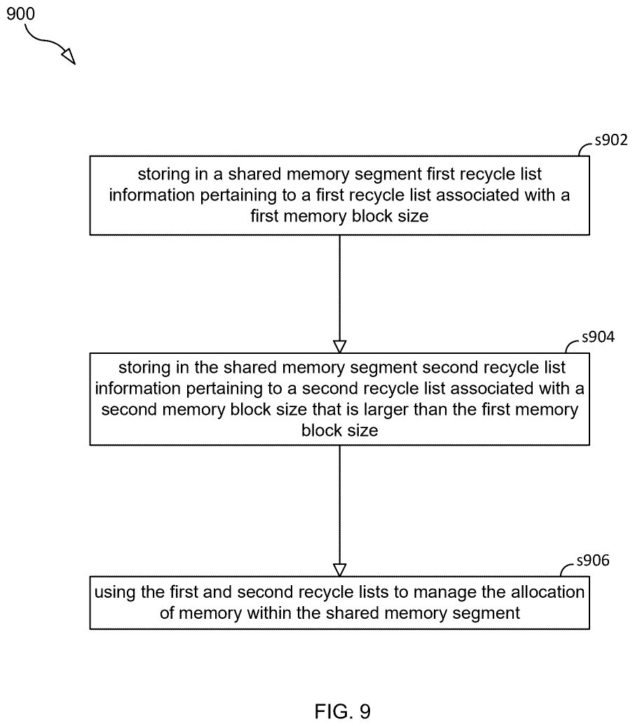

FIG. 9 is a flow chart illustrating a process 900, according to an embodiment. Process 900 may begin in step s902. Step s902 comprises storing in a shared memory segment first recycle list information pertaining to a first recycle list associated with a first memory block size. Step s904 comprises storing in the shared memory segment second recycle list information pertaining to a second recycle list associated with a second memory block size that is larger than the first memory block size. Step s906 comprises using the first and second recycle lists to manage the allocation of memory within the shared memory segment.

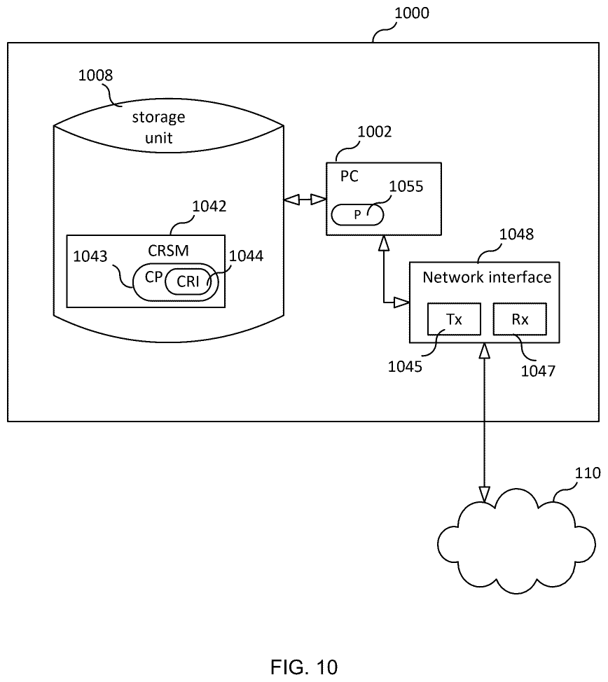

FIG. 10 is a block diagram of a node 1000, according to some embodiments. Node 1000 can be an active node or a standby node. As shown in FIG. 10, node 1000 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., node 1000 may be a distributed computing apparatus); at least one network interface 1049 (e.g., a physical interface or air interface) comprising a transmitter (Tx) 1045 and a receiver (Rx) 1047 for enabling node 1000 to transmit data to and receive data from other nodes connected to a network 110 (e.g., an Internet Protocol (IP) network) to which network interface 1049 is connected (physically or wirelessly) (e.g., network interface 1049 may be coupled to an antenna arrangement comprising one or more antennas for enabling node 1000 to wirelessly transmit/receive data); and a storage unit (a.k.a., “data storage system”) 1009, which may include one or more non-volatile storage devices and/or one or more volatile storage devices. In embodiments where PC 1002 includes a programmable processor, a computer readable storage medium (CRSM) 1042 may be provided. CRSM 1042 may store a computer program (CP) 1043 comprising computer readable instructions (CRI) 1044. CRSM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes node 1000 to perform steps described herein (e.g., steps described herein with reference to the flow charts). In other embodiments, node 1000 may be configured to perform steps described herein without the need for code. That is, for example, PC 1002 may consist merely of one or more ASICs. Hence, the features of the embodiments described herein may be implemented in hardware and/or software.

### SUMMARY OF VARIOUS EMBODIMENTS

A1. A contact center system, comprising a node comprising a plurality of modules (e.g., microservices), each module comprising a shared memory module (e.g., shared memory library), wherein the shared memory module is configured to: obtain a shared memory key and a shared memory segment size value; obtain a shared memory segment identifier (smhid) using the shared memory key and shared memory segment size value, the shared memory segment identifier identifying a shared memory segment; and use the shared memory segment identifier to attach to the shared memory segment, wherein for each of a plurality of memory block sizes, the shared memory segment stores information pertaining to a recycle list associated with the memory block size, and the plurality of memory block sizes comprises a first memory block size and a second memory block size that is greater than the first memory block size.

A2. The system of embodiment A1, wherein the contact center system is operable to receive at least 100 calls per second.

A3. The system of embodiment A1 or A2, wherein the node is configured to: in response to an indication that one of the modules is requesting the creation of an object associated with the first memory block size, determine whether a recycle list associated with the first memory block size has a length (L) that satisfies a condition (e.g., L>T1).

A4. The system of embodiment A3, wherein the node is configured such that, as a result of determining that L satisfies the condition, the node: obtains a memory address from the recycle list associated with the first memory block size, wherein the memory address identifies a memory block, removes the memory address from the recycle list, and uses memory block identified by the obtained memory address to create the object.

A5. The system of embodiment A3, wherein the node is further configured such that, as a result of determining that L does not satisfy the condition, the node: determines whether a second recycle list associated with the second memory block size has a length (L2) that satisfies a condition (e.g., L2>T2).

A6. The system of any one of embodiments A1-A5, wherein the node is configured to: in response to an indication that one of the modules is requesting the deletion of an object associated with the first memory block size, determine an end of a recycle list associated with the first memory block size.

B1. A method in a contact center system comprising a plurality of services (containers, virtual machines) configured to operate using a shared memory, the method comprising: upon arrival of a caller, storing a caller state object in an allocated portion of the shared memory (i.e., a free memory block within the shared memory) by a first service in a first container; after the caller is placed on hold, managing the caller by a second service in a second container by reading and updating the caller state object in the allocated portion of the shared memory; and connecting the caller to an agent by reading and updating the caller state object.

B2. The method of embodiment B1, further comprising: after the call disconnects, adding to a recycle list a pointer to the allocated portion of the shared memory.

B3. The method of embodiment B1 or B2, wherein storing the caller state object in an allocated portion of the shared memory comprises: determining whether a recycle list associated with a first memory block size associated with the caller state object has a length (L) that satisfies a condition (e.g., L>T1).

B4. The method of embodiment B3, further comprising, as a result of determining that L satisfies the condition: obtaining a memory address from the recycle list, wherein the memory address identifies a memory block; removing the memory address from the recycle list; and uses memory block identified by the obtained memory address to store the caller state object.

B5. The method of embodiment B3, further comprising, as a result of determining that L does not satisfy the condition: determining whether a second recycle list associated with a second memory block size has a length (L2) that satisfies a condition (e.g., L2>T2).

C1. A method comprising: storing in a shared memory segment first recycle list information pertaining to a first recycle list associated with a first memory block size; storing in the shared memory segment second recycle list information pertaining to a second recycle list associated with a second memory block size that is larger than the first memory block size; and using the first and second recycle lists to manage the allocation of memory within the shared memory segment.

C2. The method of embodiment C1, wherein using the first and second recycle lists to manage the allocation of memory within the shared memory segment comprises: in response to receiving an instruction to store or create a data object associated with the first memory block size, determining whether the length (L1) of the first recycle list satisfies a condition (e.g., L1>T1); and as a result of determining that L1 satisfies the condition: obtaining a memory address from the first recycle list, wherein the memory address identifies a memory block and removing the memory address from the first recycle list; and using the memory block identified by the obtained memory address to store the data object.

C3. The method of embodiment C1, wherein using the first and second recycle lists to manage the allocation of memory within the shared memory segment comprises: in response to receiving an instruction to store or create a data object associated with the first memory block size, determining whether the length (L1) of the first recycle list satisfies a condition (e.g., L1>T1); and as a result of determining that L1 does not satisfy the condition, storing the data object in a free memory block.

C4. The method of embodiment C1, wherein using the first and second recycle lists to manage the allocation of memory within the shared memory segment comprises: in response to receiving an instruction to store or create a data object associated with the first memory block size, determining whether the length (L1) of the first recycle list satisfies a condition (e.g., L1>T1); and as a result of determining that L1 does not satisfy the condition, determining whether the length (L2) of the second recycle list satisfies a condition (e.g., L2>T2)

D1. A computer program comprising instructions which when executed by processing circuitry of a node causes the node to perform the method of any one of the above embodiments.

D2. A carrier containing the computer program of embodiment D1, wherein the carrier is one of an electronic signal, an optical signal, a radio signal, and a computer readable storage medium.

E1. A node in a communication system, the node being configured to perform the method of any one of embodiments B1-B5 or C1-C4.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A contact center system, comprising a node comprising a first module and a second module, the first module comprising a first shared memory module, wherein the first shared memory module is configured to:
obtain a shared memory key and a shared memory segment size value;
obtain a shared memory segment identifier using the shared memory key and shared memory segment size value, the shared memory segment identifier identifying a shared memory segment; and
use the shared memory segment identifier to attach to the shared memory segment, wherein
for each of a plurality of memory block sizes, the shared memory segment stores information pertaining to a recycle list associated with the memory block size, and
the plurality of memory block sizes comprises a first memory block size and a second memory block size that is greater than the first memory block size.

2. The system of claim 1, wherein the contact center system is operable to receive at least one-hundred calls per second.

3. The system of claim 1, wherein the node is configured to:
in response to an indication that a module of the node is requesting the creation of an object associated with the first memory block size, determine whether a recycle list associated with the first memory block size has a length (L) that satisfies a condition.

4. The system of claim 3, wherein
the node is configured such that, as a result of determining that L satisfies the condition, the node:
obtains a memory address from the recycle list associated with the first memory block size, wherein the memory address identifies a memory block,
removes the memory address from the recycle list, and uses memory block identified by the obtained memory address to create the object.

5. The system of claim 3, wherein the node is further configured such that, as a result of determining that L does not satisfy the condition, the node:
determines whether a second recycle list associated with the second memory block size has a length, L2, that satisfies a condition.

6. The system of claim 1, wherein the node is configured to:
in response to an indication that a module of the node is requesting the deletion of an object associated with the first memory block size, determine an end of a recycle list associated with the first memory block size.

7. A method in a contact center system comprising a plurality of services configured to operate using a shared memory, the method comprising:
upon arrival of a caller, storing a caller state object in an allocated portion of the shared memory by a first service in a first container;
after the caller is placed on hold, managing the caller by a second service in a second container by reading and updating the caller state object in the allocated portion of the shared memory; and
connecting the caller to an agent by reading and updating the caller state object.

8. The method of claim 7, further comprising:
after the call disconnects, adding to a recycle list a pointer to the allocated portion of the shared memory.

9. The method of claim 7, wherein storing the caller state object in an allocated portion of the shared memory comprises:
determining whether a recycle list associated with a first memory block size associated with the caller state object has a length, L, that satisfies a condition.

10. The method of claim 9, further comprising, as a result of determining that L satisfies the condition:
obtaining a memory address from the recycle list, wherein the memory address identifies a memory block;
removing the memory address from the recycle list; and
uses memory block identified by the obtained memory address to store the caller state object.

11. The method of claim 9, further comprising, as a result of determining that L does not satisfy the condition:
determining whether a second recycle list associated with a second memory block size has a length (L2) that satisfies a condition.

12. A non-transitory computer readable storage medium storing a computer program comprising instructions for configuring a node comprising processing circuitry for executing the instructions to perform the method of claim 7.

13. A node in a communication system, the node comprising:
processing circuitry for executing instructions; and
memory storing a computer program comprising instructions for configuring the node to perform the method of claim 7.

14. A method comprising:
storing in a shared memory segment first recycle list information pertaining to a first recycle list associated with a first memory block size;
storing in the shared memory segment second recycle list information pertaining to a second recycle list associated with a second memory block size that is larger than the first memory block size; and
using the first and second recycle lists to manage the allocation of memory within the shared memory segment, wherein using the first and second recycle lists to manage the allocation of memory within the shared memory segment comprises:
in response to receiving an instruction to store or create a data object associated with the first memory block size, determining whether the length, L1, of the first recycle list is greater than a first threshold, T1, wherein T1>1; and
as a result of determining that L1 is greater than T1:
obtaining a memory address from the first recycle list, wherein the memory address identifies a memory block and removing the memory address from the first recycle list; and
using the memory block identified by the obtained memory address to store the data object.

15. The method of claim 14, wherein using the first and second recycle lists to manage the allocation of memory within the shared memory segment further comprises:
in response to receiving an instruction to store or create a data object associated with the second memory block size, determining whether the length, L2, of the second recycle list is greater than a second threshold, T2, wherein T2>T1; and
as a result of determining that L2 is not greater than T2, storing the data object in a free memory block.

16. The method of claim 14, wherein using the first and second recycle lists to manage the allocation of memory within the shared memory segment further comprises:
in response to receiving an instruction to store or create a data object associated with the second memory block size, determining whether the length, L2, of the second recycle list is greater than a second threshold, T2, wherein T2>T1;
as a result of determining that L2 is not greater than T2, determining whether L1 is greater than T1; and
as a result of determining that L1 is greater than T1:
obtaining a memory address from the first recycle list, wherein the memory address identifies a memory block and removing the memory address from the first recycle list; and
using the memory block identified by the obtained memory address to store the data object.

17. A non-transitory computer readable storage medium storing a computer program comprising instructions for configuring a node comprising processing circuitry for executing the instructions to perform the method of claim 14.

18. A node in a communication system, the node comprising:
processing circuitry for executing instructions; and
memory storing a computer program comprising instructions for configuring the node to perform the method of claim 14.
